(19) United States
(12) Patent Application Publication
(10) Pub. No.: US 2025/0081048 A1
(43) Pub. Date: Mar. 6, 2025

(54) PERCEPTION ENHANCED MOBILITY MANAGEMENT

(71) Applicant: QUALCOMM Incorporated, San Diego, CA (US)

(72) Inventors: Yann LEBRUN, Velizy-Villacoublay (FR); Peerapol TINNAKORNSRISUPHAP, San Diego, CA (US); Simone MERLIN, San Diego, CA (US); Hussein METWALY SAAD, San Diego, CA (US); Mickael MONDET, Louannec (FR); Chih-Ping LI, San Diego, CA (US); Ravi AGARWAL, San Diego, CA (US)

(21) Appl. No.: 18/460,422

(22) Filed: Sep. 1, 2023

(51) Int. Cl. H04W 36/00; H04B 17/318; H04W 76/20

(52) U.S. Cl. CPC H04W 36/0058; H04B 17/328; H04W 36/00837; H04W 76/20

(57) ABSTRACT

Certain aspects of the present disclosure provide techniques for mobility management. A method of wireless communications by a user equipment includes obtaining one or more criteria associated with triggering at least one of cell measurement or handover. The one or more updated criteria are based at least in part on network environment perception information. The method includes obtaining one or more updated criteria associated with the triggering at least one of cell measurement or handover.

### FIELD OF THE DISCLOSURE

Aspects of the present disclosure relate to wireless communications, and more particularly, to techniques for mobility management.

### BACKGROUND

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communications by a user equipment. The method includes obtaining one or more criteria associated with triggering at least one of cell measurement or handover; and obtaining one or more updated criteria associated with the triggering at least one of cell measurement or handover. In some aspects, the one or more updated criteria are based at least in part on network environment perception information.

Another aspect provides a method of wireless communications by a network entity. The method includes outputting for transmission one or more criteria associated with triggering at least one of cell measurement or handover; and outputting for transmission one or more updated criteria associated with the triggering at least one of cell measurement or handover based at least in part on network environment perception information or signaling configuring a user equipment to autonomously update the one or more criteria based at least in part on network environment perception information.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example network environment.

FIG. 6 depicts a process flow for handover in a network between a UE, a serving cell, and a target cell.

FIG. 7 depicts an example network environment.

FIG. 8 depicts example measurement events.

FIG. 9 depicts an example network environment.

FIG. 10 depicts a process flow for configuring measurement events in a network between a UE and a network entity.

FIG. 11 depicts an example network environment.

FIG. 12 depicts a process flow for configuring measurement events in a network between a UE and a network entity.

FIG. 13 depicts a method for wireless communications.

FIG. 14 depicts a method for wireless communications.

FIG. 15 depicts aspects of an example communications device.

FIG. 16 depicts aspects of an example communications device.

### DETAILED DESCRIPTION

Aspects of the present disclosure provide apparatuses, methods, processing systems, and computer-readable mediums for perception enhanced mobility management.

Devices in a communication network, such as base stations and user equipment may be equipped with sensor that collect perception information providing network environment awareness to the device. In some aspects, the device can exchange the perception information with each other.

According to certain aspects, the perception information can be used enhance mobility management. In some aspects, user equipment are configured with criteria for triggering cell measurements and criteria for triggering handover. Using perception information, the criteria can be better selected. Further, the network environment can change over time, for example due to the user equipment moving, presence of blockers, etc. Accordingly, the perception information can be used to dynamically update the criteria for triggering cell measurement and/or the criteria for triggering handover.

In some aspects, a network entity may be responsible for updating the criteria based on the perception information. For example, the network entity may send additional signaling, such as a radio resource control (RRC) measurement event message that configures the user equipment with the updated criteria.

In some aspects, the user equipment may be responsible for updating the criteria based on the perception information. For example, the network entity may configure the user equipment to autonomously update the criteria or may configure the user equipment to suggest the updated criteria to the network entity. In some aspects, based on the updated criteria, the user equipment may send a pre-emptive measurement report triggering handover. The pre-emptive measurement report may include a field indicating the measurement report is a pre-emptive measurement report.

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

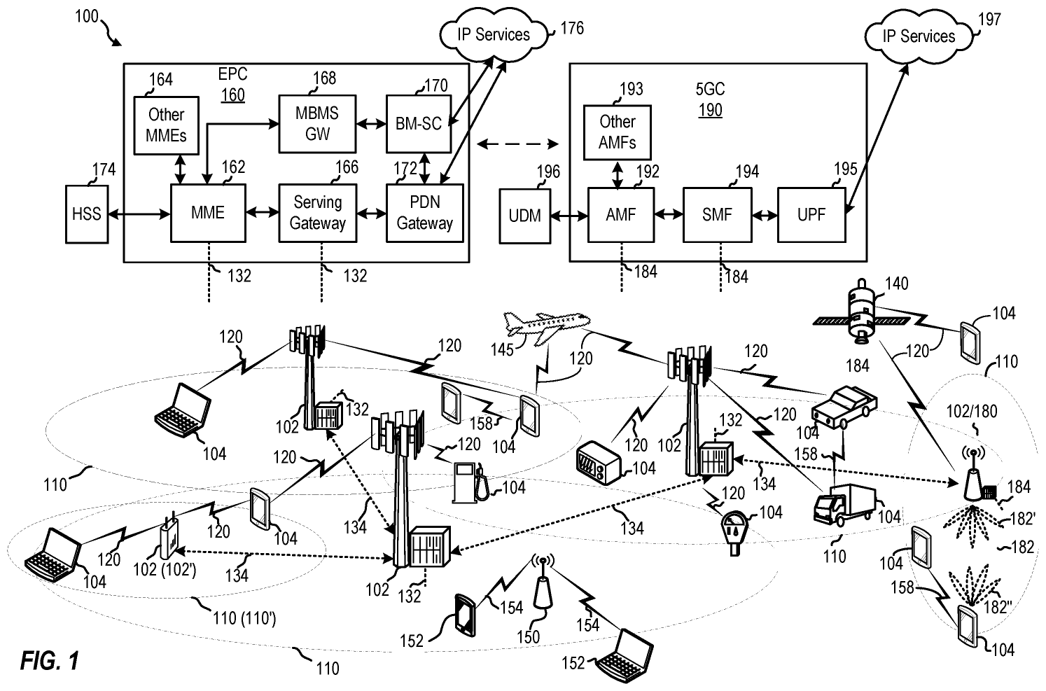

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

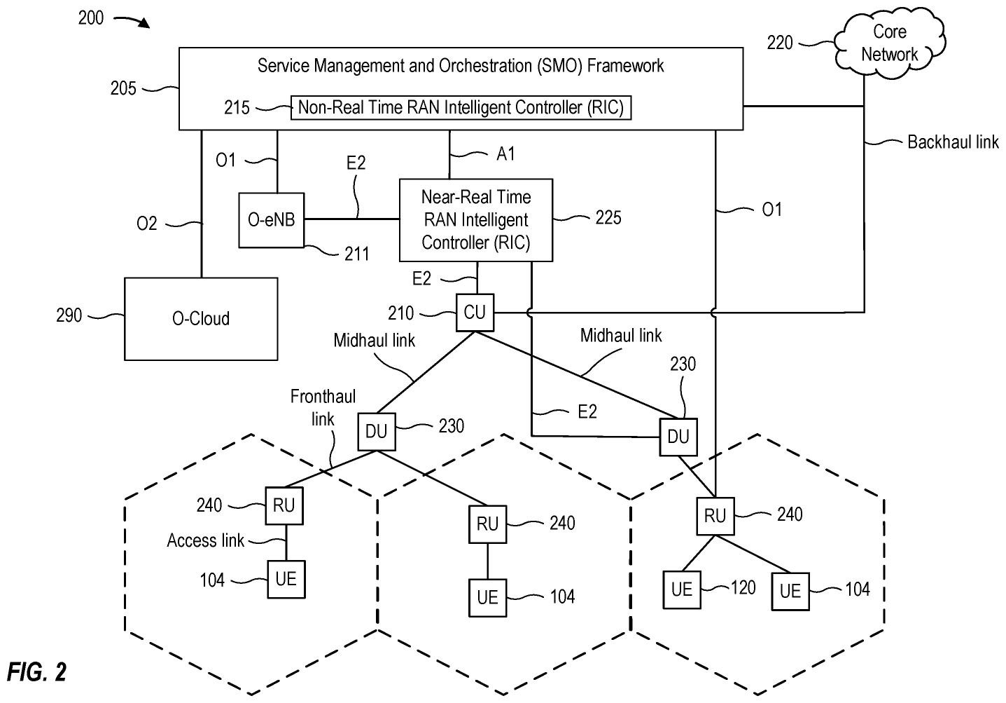

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

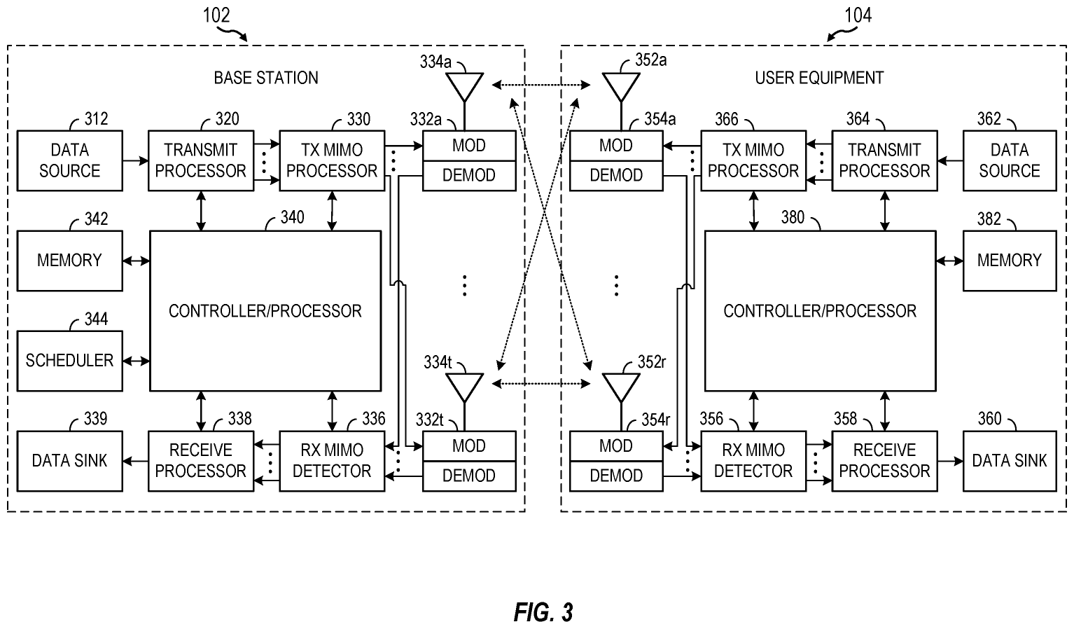

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

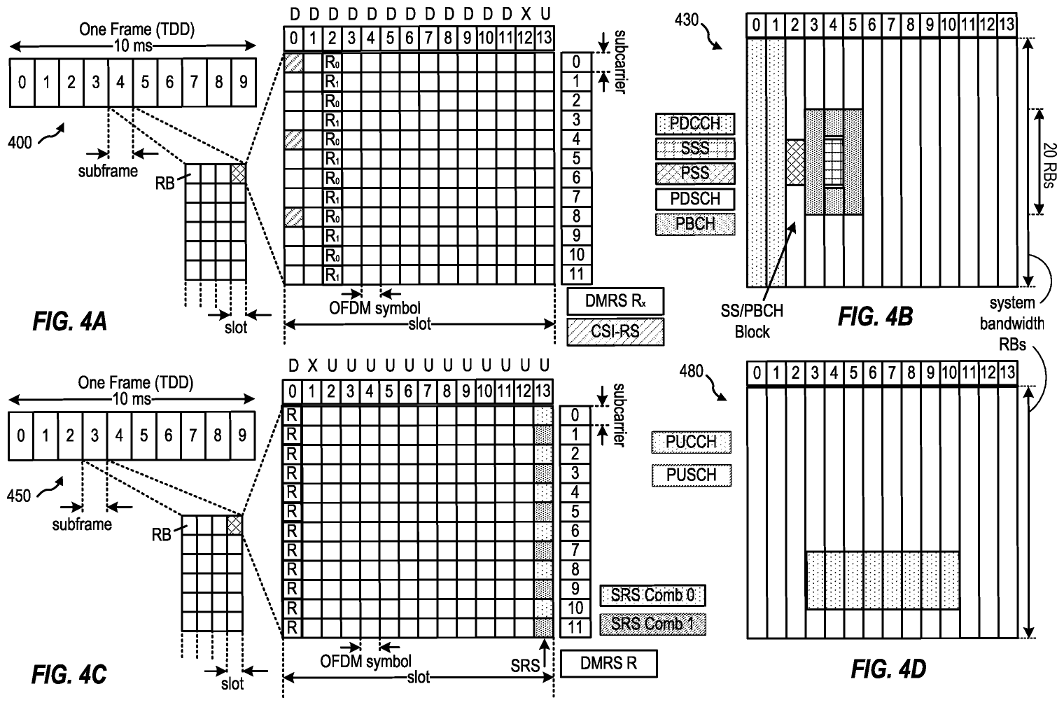

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 21×15 kHz, where p is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 s.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

In wireless communication networks (e.g., such as wireless communication network 100), handover helps ensure seamless connectivity as mobile devices (e.g., such as UEs 104) move between different cells or access points (e.g., BSs 102) within the network.

Handover may include intra-cell handover where the mobile device moves within the coverage of the same cell. Handover may include inter-cell handover where the mobile device moves from the coverage area of one cell to another cell within the same network. Handover may include inter-RAT handover where the mobile device moves between different RATs (e.g., from LTE to 5G or from 5G to LTE, from Wi-Fi to cellular or cellular to Wi-Fi, etc.). Handover may include condition handover (CHO).

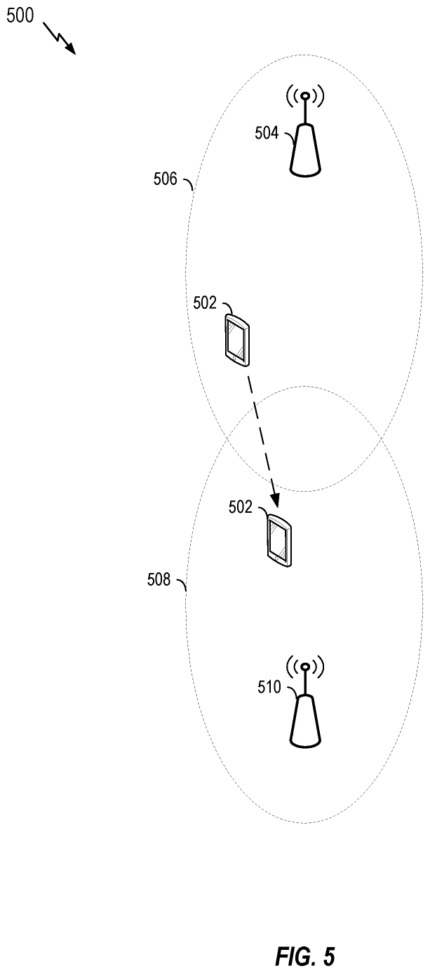

FIG. 5 depicts an example network environment 500 in which a UE 502 moves from coverage area 506 of a first cell 504 to the coverage area 508 of a second cell 510. Thus, the UE 502 may handover from the first cell 504 (e.g., a source cell) to the second cell 510 (e.g., a target cell).

In the sub-6 GHz bands, handover failure may be rare. However, in mmWave, the number of handover failures may be higher due to more frequent handover (e.g., due to denser networks), more time to complete handover (e.g., due to beam association), and quicker changes to signal quality. Conditional handover may improve handover performance

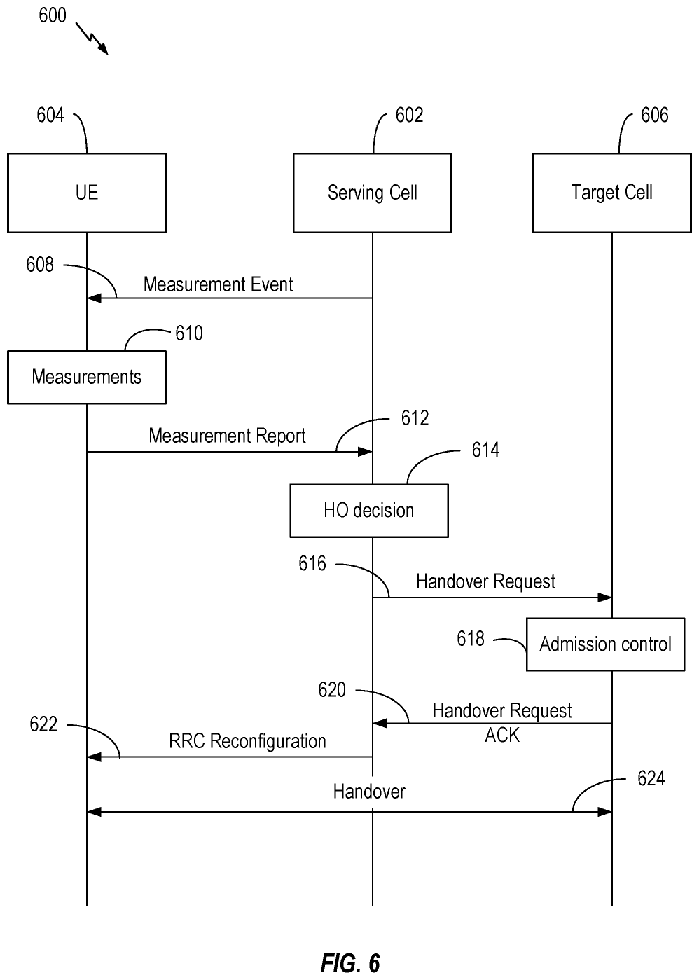

FIG. 6 depicts a process flow 600 for an example handover in a network between a UE 604, a serving cell 602, and a target cell 606. As shown, at operation 608, the serving cell 602 configures the UE 604 with a measurement event.

In some aspects, Measurement Event message is an RRC message that configures triggers and/or conditions associated with when the UE 604 performs handover related measurements, such as signal strength of the serving cell and/or neighboring cells. The triggers and/or conditions may include thresholds for signal strength or signal quality that, when met, trigger the mobile device to perform measurement reports. In some aspects, measurement or handover is triggered when one or more signal quality measurements (e.g., RSRP or SINR) meet a configured signal quality threshold for a configured threshold duration (e.g., a TTT duration). In some aspects, the measurement event message is a MeasObjectNR information element (IE) that specifies information applicable for inter-frequency measurements and intra-frequency measurements of SS/PBCH block(s) and/or CSI-RS. In some aspects, the measurement event message is a ReportConfigNR IE that specifies criteria for triggering of an NR measurement reporting event or of a CHO, cell planned allocation (CPA) handover or cell power control (CPC) handover event or of an layer 2 (L2) U2N relay measurement reporting event.

As shown in FIG. 6, at operation 610 the UE 604 performs measurements. For example, the UE 604 may perform inter-cell measurements and/or intra-cell measurements.

When the conditions specified in the Measurement Event message are met (e.g., signal strength of the serving cell falls below a certain threshold or neighboring cells becomes stronger than the serving cell by a certain threshold for a threshold TTT duration), the mobile device generates measurement reports and sends them to the network. As shown in FIG. 6, at operation 612 the UE 604 sends a measurement report to the serving cell 602.

The measurement report is used by the network to make informed handover decisions. For example, if the signal strength from the current cell deteriorates beyond a certain level, or if the signal strength from a neighboring cell becomes stronger than the signal strength from the current cell, the network can initiate a handover to a neighboring cell with better signal quality. As shown in FIG. 6, at operation 614 the serving cell 602 makes a handover decision based on the measurement report from the UE 604. At operation 616, the serving cell 602 sends a handover request to the target cell 606. The target cell 606 may perform admission control 618 to decide whether to accept the handover request.

If handover is accepted, the serving cell sends a message to the UE with details of the target cell and the UE starts the handover process. As shown in FIG. 6, at operation 620, the target cell 606 sends a handover request acknowledge to the source cell 602. At operation 622, the serving cell 602 sends a RRC Reconfiguration message to the UE 604 with the details of the target cell 606. Then, at operation 624, the UE 604 initiates handover with the target cell 606.

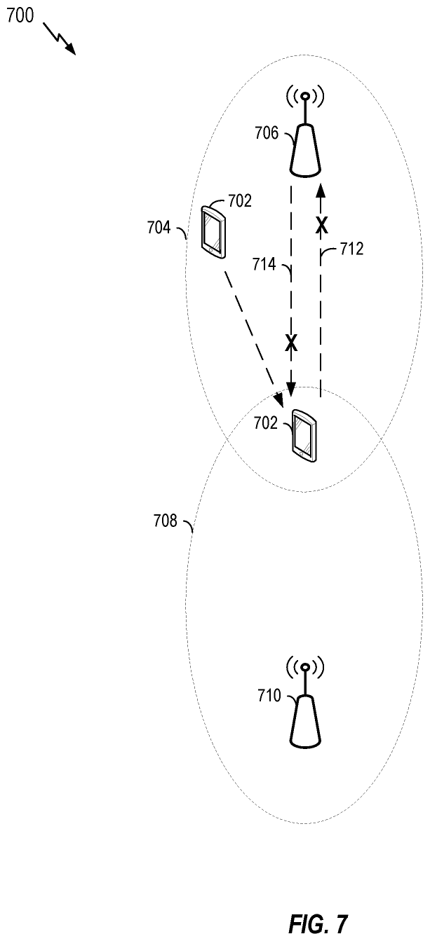

Performance of mobility management depends on the Measurement Event criteria set by the network. FIG. 7 depicts an example network environment 700. In some examples, if the signal quality thresholds are too high, the UE 702 will send a measurement report 712 late and the measurement report 712 may not be received by the serving cell 706 or the UE 702 may fail to receive the RRC Reconfiguration message 714 from the serving cell 706. A trigger duration may be used to avoid unnecessary handovers between cells. However, if the trigger duration is too large, the handover from the serving cell 706 in coverage area 704 to the target cell 710 in coverage area 708 will be delayed and could cause beam failure when the UE 702 is moving and the channel quality changes quickly.

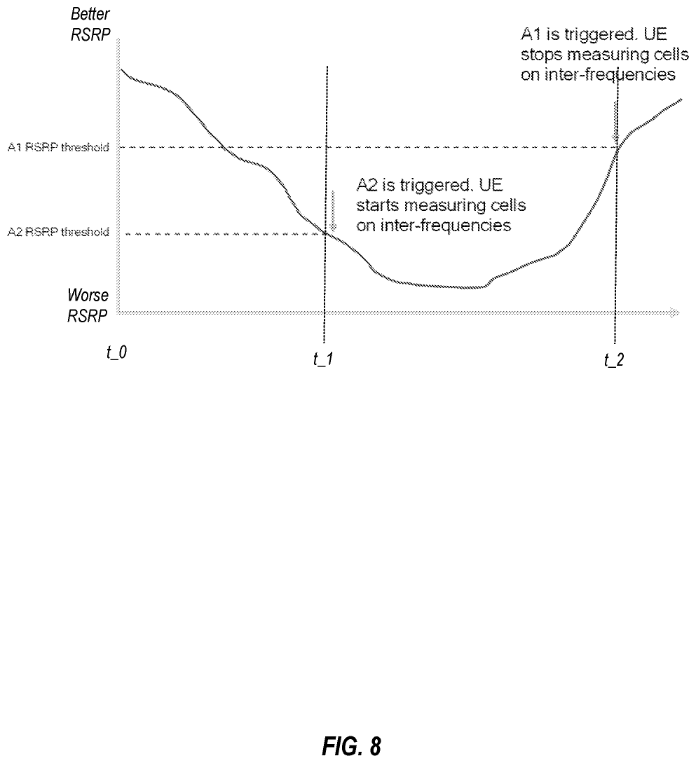

As discussed above, the network configures the UE with measurement events. FIG. 8 depicts example A1 and A2 measurement events.

The UE measures signal quality of nearby cells to prepare for handover. For cells on different frequencies (i.e., inter-frequency), the UE may perform measurements when the UE moves into far-cell conditions and the UE stops measurements when the UE moves to near-cell conditions. Enabling and disabling inter-frequency measurements may be set through the A2 and A1 events.

The A2 measurement events specifies the UE starts inter-frequency measurements when the signal quality of the serving cell is lower than a specified threshold. For example, the A2 measurement event may be used to trigger a mobility procedure when the UE moves towards cell edge. The A2 measurement event does not involve any neighbor cell measurements, so the A2 measurement event may be used to trigger a blind mobility handover or the A2 measurement event may be used to trigger neighbor cell measurements which can then be used for handover. As shown in FIG. 8, at t₀, the serving cell measurements at the UE are above the A2 RSRP threshold until t₁ at which the serving cell measurements at the UE are below the A2 RSRP threshold, for example, as the UE moves away from the serving cell or in the presence of a blocker. Accordingly, at t₁ the A2 measurement event is triggered and the UE starts inter-frequency cell measurements.

The A1 measurement event specifies the UE stops inter-frequency measurements when signal quality of the serving cell is higher than a specified threshold. The A1 measurement event may be triggered when the serving cell becomes better than the threshold. The A1 measurement may be used to cancel an ongoing handover procedure, such as where the UE moves towards cell edge and triggers a mobility procedure, but then subsequently moves back into good coverage before the mobility procedure has completed. As shown in FIG. 8, at t₁, the serving cell measurements at the UE are below the A1 RSRP threshold until t₂ at which the serving cell measurements at the UE are above the A1 RSRP threshold, for example, as the UE moves back towards the serving cell or in the blocker is no longer present. Accordingly, at t₂ the A1 measurement event is triggered and the UE stops the inter-frequency cell measurements.

Another example measurement event is the A3 measurement event. The A3 measurement specifies the UE triggers an inter-frequency handover, when a neighbor cell becomes stronger than a special cell (SpCell), for example a primary cell of the Master Cell Group (MCG) or of a Secondary Cell Group (SCG), by a specified offset threshold (e.g., 4 dB for at least a 200 ms time-to-trigger duration). The offset threshold may be positive or negative.

Another example measurement event is the A4 measurement event. The A4 measurement event specifies that the UE triggers handover to a neighbor cell when the signal quality of the neighboring cell becomes better than a specified threshold. The A4 measurement event may be used for handover procedures which do not depend upon the coverage of the serving cell. For example, for load balancing the decision to handover a UE away from the serving cell may be due to load conditions rather than radio conditions. In this case, the UE only verifies that the target cell signal quality is better than the specified signal quality threshold and can provide adequate coverage.

Another example measurement event is the A5 measurement event. The A5 measurement event specifies that the UE triggers a handover to a neighbor cell when the SpCell becomes worse than a first specified threshold while the neighboring cell becomes better than a second specified threshold. The A5 measurement event may be for intra-frequency handover or inter-frequency handover.

Another example measurement event is the A6 measurement event. The A6 measurement event specifies that the UE triggers handover, when a neighbor cell signal quality is better than a secondary cell (SCell) signal quality by a specified offset threshold.

The measurement event message may also configure a time-to-trigger (e.g., timeToTrigger parameter in the ReportConfigNR IE) that specifies a time during which specific criteria for the event needs to be met in order to execute the event.

In some systems, the network configures the UE with handover criteria without full information of the network environment. For example, the base station may not have information regarding the surroundings of the base station and the UE, the base station may not have information regarding the presence of blockers or incoming blockers, the base station may not have information of the timing and duration of the blockers, and/or the base station may not have information regarding the radio frequency mapping (RF).

Further, the management of nearby-cell measurements based on information regarding near-cell and far-cell alone may be limited. For example, an incoming blockage in near-cell conditions may cause beam failure since the UE may not have nearby cells to rely on for handover. When going towards the cell edge with fast mobility the UE may have only few opportunities to find a target cell. On the other hand, measuring nearby cell when UE is static provides little or no new information and wastes power.

Accordingly, for optimal mobility management, the handover criteria set by the network may be enhanced with additional information about the environment.

In certain systems and use cases, such as extended reality (XR) and automotive use cases, the UE and/or the base station may have sensors that provide network environment perception information. Some examples of perception sensors include RF measurement sensors, cameras, and inertial measurement units (IMUs). An IMU is a sensor used to measure and report on motion (e.g., acceleration) and orientation (e.g., angular velocity) with respect to an inertial frame of reference. An IMU may include an accelerometer, a gyroscope, and magnetometer. The accelerometer measures linear acceleration (e.g., along three orthogonal axes X, Y, and Z). The accelerometer may detect movements. The gyroscope measures angular velocity or the rate of rotation (e.g., around the same three axes). The gyroscope may help in determining the device's orientation and the rate at which the device is turning. The magnetometer measures the strength and direction of a magnetic field, which may help in determining the device's orientation relative to Earth's magnetic field and can be used for compass-like functionality.

The perception information can be used to build awareness of the network environment. For example, the perception information can be used to estimate the device's position and orientation (e.g., six degrees of freedom, 6DoF) by combining camera and IMU sensor information. As another example, the perception information can be used to detect presence of an object blocking (i.e., a “blocker”) an RF link, for example, by camera sensors or a processed version of camera sensor data (e.g., depth maps). The perception information can also include a mobility, timing, and duration of the presence of the blocker. As another example, the perception information can be used to detect the presence of reflectors. As another example, the perception information can be used to estimate mobility and speed of the device, for example, using IMU sensors and/or 6DoF data. As yet another example, the perception information can be used to determine the RF mapping. For example, the RF mapping may be obtained at the base station during a training phase using collected measurement (e.g., of SRS and/or CSI-RS) from multiple UEs and their positions.

Accordingly, aspects of the present disclosure provide enhanced mobility management using network environment perception information. As used herein, network environment perception information may refer to information collected by sensors of a device, information received from another device and collected by sensors of the other device, and/or information determined from the sensor information.

According to certain aspects, user equipment are configured with criteria for triggering cell measurements and criteria for triggering handover. Using perception information, the criteria can be better selected. Further, the network environment can change over time, for example due to the user equipment moving, presence of blockers, etc. Accordingly, the perception information can be used to dynamically update the criteria for triggering cell measurement and/or the criteria for triggering handover.

According to certain aspects, a network entity may be responsible for updating the criteria based on the perception information. In some aspects, after sending a first measurement event message (e.g., a first ReportConfigNR IE) configuring first criteria at a UE for measurement and/or handover, the network may adjust the criteria based on network environment perception information and sends a second measurement event message (e.g., a second ReportConfigNR IE) configuring the updated criteria at a UE for the measurement and/or handover. In some aspects, the network entity may configure the UE in a medium access control (MAC) control element (CE) and/or in downlink control information (DCI).

In some aspects, a base station may collect the network environment perception information with sensors at the base station. In some aspects, the base station may receive network environment perception information from one or multiple UEs. In some aspects, the network entity may both collect the network environment perception information with sensors and receive network environment perception information from one or more UEs. The base station can then use the network environment perception information to determine the updated criteria for measurement and/or handover.

In some aspects, the network may use the network environment perception information to adjust nearby cell measurements. In some aspects, the network may update the measurement criteria at the UE via an RRC measurement event message (e.g., ReportConfigNR IE) to optimize the measurement criteria at the UE. In some aspects, the network entity may update the UE in a MAC-CE and/or DCI.

Intra-frequency measurements by the UE have overhead at the UE. Different nearby cells may use different SSB configurations with different numbers of SSBs, different offsets, or different periodicities that the UE may monitor. Based on the network environment perception information, the network can instruct the UE to increase and/or reduce measurements of nearby intra-frequency cells to save power at the UE.

In some aspects, the network may update criteria at the UE for inter-frequency measurements and handover. In some aspects, the network may update A1, A2, A3, A4, A5, A6, or other event criteria (e.g., inter-RAT measurement event criteria) based on the network environment perception information.

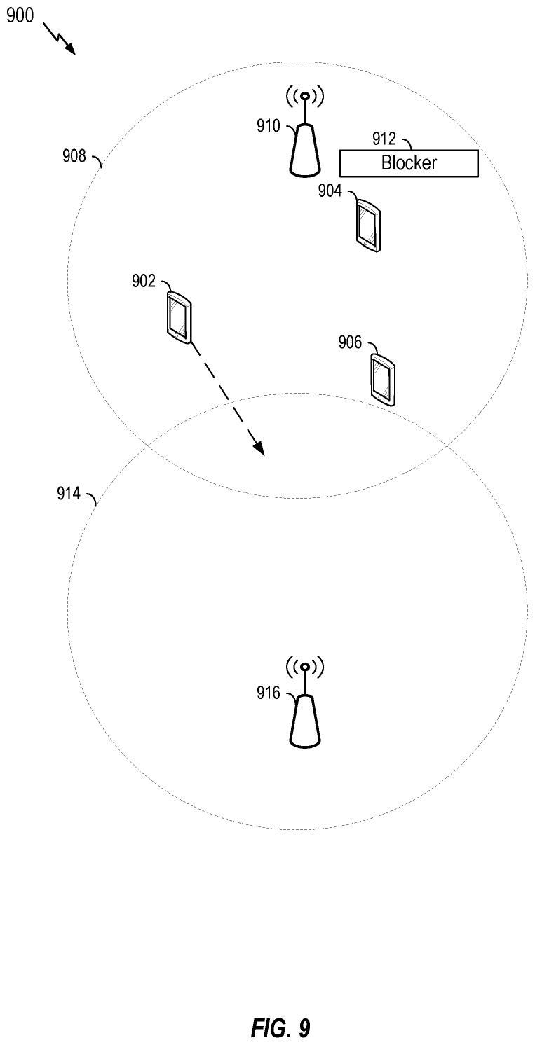

FIG. 9 depicts an example network environment 900. In one example shown in FIG. 9, based on the network environment perception information the base station 910 can detect a UE 904 in near-cell (i.e., near to the base station 910 in the coverage area 908) that is close to a blocker 912. In this example, the base station 910 may update the measurement and/or handover criteria at the UE 904 to prepare a potential rapid RF link degradation. For example, the base station 910 may update the A2 event configuration at the UE 904 to force the UE 904 to search for inter-frequency cells.

In another example shown in FIG. 9, based on the network environment perception information the base station 910 can detect a UE 902 in far-cell (e.g., further from the base station 910 and closer to the edges of the coverage area 908) that moving towards the coverage area 914 of the base station 916. In this example, the base station 910 may update the measurement and/or handover criteria at the UE 902 to reduce a time-to-trigger duration to trigger earlier handover of the UE 902 to the base station 916. For example, the base station 910 may update the A2 event configuration at the UE 902 to force the UE 902 to trigger measurements. Based on awareness of the mobility of the UE 902, the base station 910 may update the SSB based on measurement timing configuration (SMTC) and/or the measurement gap configuration at the UE 902.

In another example shown in FIG. 9, based on the network environment perception information the base station 910 can detect a UE 906 in far-cell (i.e., far from the base station 910 in the coverage area 908) with no mobility. In this example, the base station 910 may update the measurement and/or handover criteria at the UE 902 to increase the time-to-trigger duration, or adjust SSB filtering parameters, to avoid frequent handover of the UE 906 between the base station 910 and the base station 916.

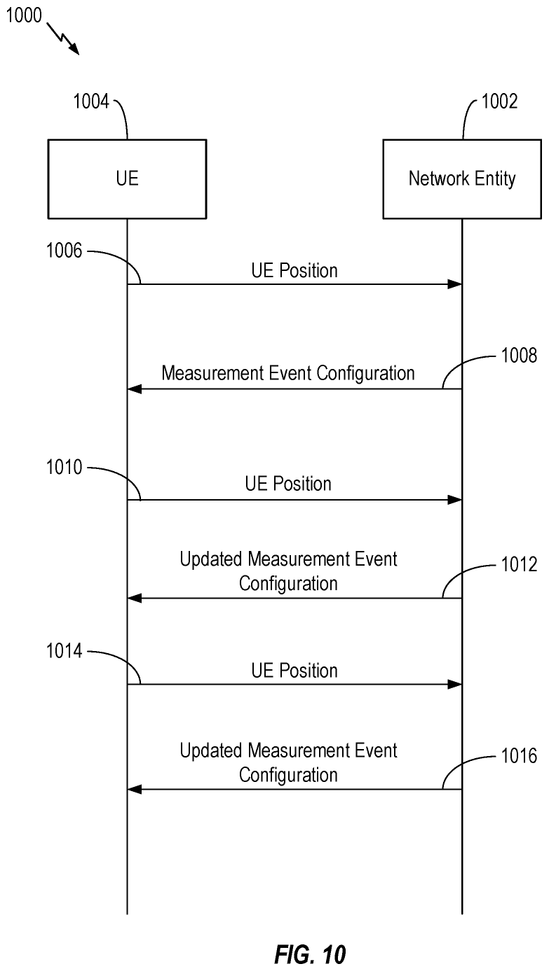

FIG. 10 depicts a process flow 100 for configuring measurement events based on network environment perception information in a network between a UE 1004 and a network entity 1002. In some aspects, the network entity 1002 may be an example of the BS 102 depicted and described with respect to FIGS. 1 and 3 or a disaggregated base station depicted and described with respect to FIG. 2. Similarly, the UE 1004 may be an example of UE 104 depicted and described with respect to FIGS. 1 and 3. However, in other aspects, UE 1004 may be another type of wireless communications device and network entity 1002 may be another type of network entity or network node, such as those described herein.

In some aspects, the network entity 1002 may be a serving cell for the UE 1004. In some aspects, the network entity 1002 may be equipped with sensors to collect network environment perception information. Additionally or alternatively, the network entity 1002 may receive network environment perception information from the UE 1004.

As shown in FIG. 10, at operation 1006, the UE 1004 may transmit signaling that indicates the position of the UE 1004 to the network entity 1002. In some aspects, based on the UE position and information the network entity 1002 may have of the environment (e.g., presence, timing, direction of blockers, the UE's position and mobility, etc.), from the network environment perception information, at operation 1008, the network entity 1002 may configure initial measurement and handover criteria at the UE 1004 as a measurement even configuration.

As the UE's position and network environment change, the network entity 1002 may update the measurement and handover criteria at the UE 1004. For example, the network entity 1002 may continue to collect network environment perception information. Further, at operation 1010, the network entity 1002 may receive signaling from the UE 1004 that indicates a changed position of the UE 1004 to the network entity 1002. In some aspects, based on the changed UE position and information the network entity 1002 may have of the environment, from the network environment perception information, at operation 1012, the network entity 1002 may configure updated measurement and handover criteria at the UE 1004 as an updated measurement event configuration. For example, based on information of the UE's position and mobility, the network entity 1002 may detect that the UE 1004 is moving quickly to far-cell conditions and may update the handover criteria accordingly.

The network entity 1002 may continue to collect network environment perception information and, at operation 1014, the network entity 1002 may receive signaling from the UE 1004 that indicates the position of the UE 1004 to the network entity 1002. In some aspects, the network entity 1002 may detect that the 1002 is in the far-cell and is static.

In some aspects, based on the static UE position and information the network entity 1002 may have of the environment, from the network environment perception information, at operation 1016, the network entity 1002 may configure further updated measurement and handover criteria at the UE 1004. For example, the network entity 1002 may update the handover criteria at the UE 1004 to avoid frequency switching between the cells.

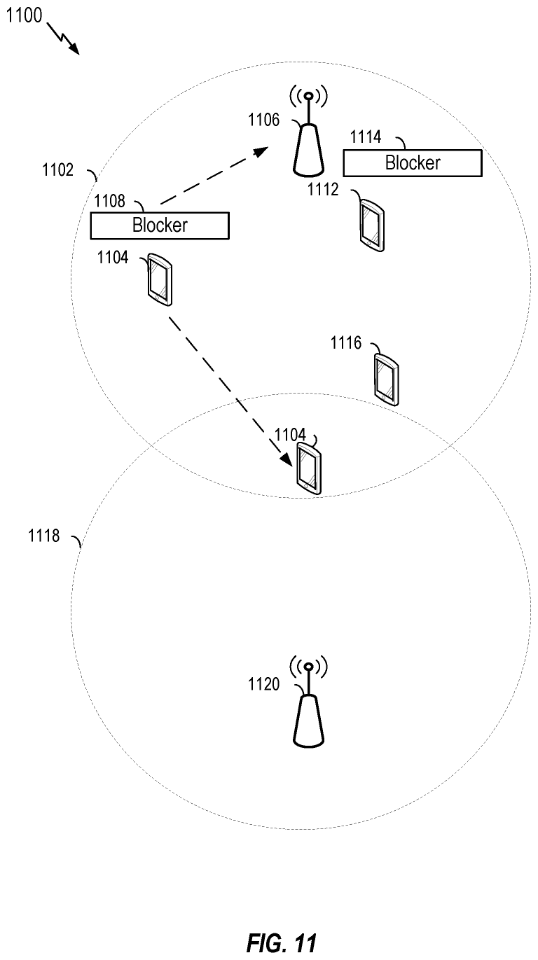

FIG. 11 depicts an example network environment 1100. FIG. 11 illustrates UEs in various network environments that a UE may detect with network environment perception information. As shown, UE 1104 may be near-cell (e.g., further from the edge of the coverage area 1102 and closer to the base station 1106) with a nearby blocker 1108, where the blocker 1108 is moving away from the UE 1104 and the UE 1104 is moving away from the blocker 1108 and towards a far-cell position to the coverage area 1118 of base station 1120. UE 1112 may be a static UE in near-cell with a nearby static blocker 1114. UE 1116 may be static in far-cell with no nearby blockers.

In one example, the UE 1104 moving towards the far-cell may adjust its criteria to trigger measurements. In another example, the static UE 1116 may adjust its criteria to stop or reduce measurements (e.g., use a different SSB configuration, a different offset, a different periodicity) to save power on inter-frequency and/or intra-frequency measurements. In another example, the UE 1112 may adjust its criteria to trigger inter-frequency measurements in anticipation of handover due to the presence of the blocker 1114.

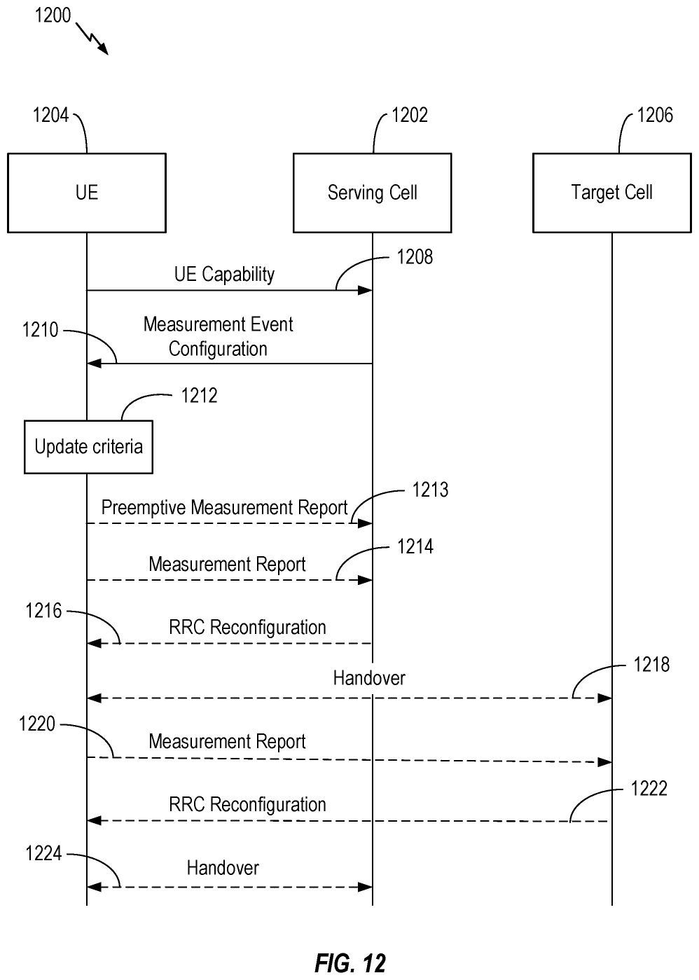

FIG. 12 depicts a process flow 1200 for configuring measurement events in a network between a UE and a network entity. In some aspects, the network entity 1202 may be an example of the BS 102 depicted and described with respect to FIGS. 1 and 3 or a disaggregated base station depicted and described with respect to FIG. 2. Similarly, the UE 1204 may be an example of UE 104 depicted and described with respect to FIGS. 1 and 3. However, in other aspects, UE 1204 may be another type of wireless communications device and network entity 1202 may be another type of network entity or network node, such as those described herein.

According to certain aspects, the UE 1204 may be responsible for updating the criteria based on the perception information. For example, the UE 1204 may update the criteria based on the perception information without receiving an updated measurement event configuration from the network entity 1202.

In some aspects, the network entity 1202 may be a serving cell for the UE 1204. In some aspects, the UE 1204 may be equipped with sensors to collect network environment perception information. Additionally or alternatively, the UE 1204 may receive network environment perception information from the network entity 1202.

As shown, at operation 1208, the UE 1204 may signal its capability information to the serving cell 1202. In some aspects, the UE 1204 may signal its perception capability.

At operation 1210, the serving cell 1202 may signal the measurement event configuration to the UE 1204. In some aspects, the measurement event configuration configures the UE 1204 to autonomously update (or to suggest updated) handover and/or measurement criteria. In some aspects, the serving cell 1202 configures the UE 1204 via a ReportConfigNR IE to autonomously update the criteria. In some aspects, the serving cell 1202 configures the UE 1204 in a MAC-CE and/or DCI.

In some aspects, the serving cell 1202 configures the UE 1204 to suggest the updated criteria to the serving cell 1202. The serving cell 1202 may then configure updated criteria at the UE 1204 based on the suggested updated criteria. For example, the serving cell 1202 may accept, reject, or modify the suggested criteria. In some aspects, the serving cell 1202 may configure the UE 1204 via a measurement event message (e.g., the ReportConfigNR IE) to suggest the updated the criteria. In some aspects, the serving cell 1202 may configure the UE 1204 in a MAC-CE and/or DCI.

The UE 1204 may collect network environment perception information. In some aspects, the UE 1204 collects the network environment perception information with sensors at the UE. In some aspects, the UE 1204 receives network environment perception information from the serving cell 1202 and/or from other UEs (not shown). In some aspects, the UE 1204 both collects the network environment perception information with sensors and receives network environment perception information from the serving cell 1202 and/or the other UEs. At operation 1212, the UE 1204 updates the criteria based on the collected network environment perception information.

In some aspects, based on the updated criteria, the UE 1202 may send a pre-emptive measurement report (e.g., a measurement report that would not be triggered according to the initial criteria) at operation 1213. The pre-emptive measurement report may include a field indicating the measurement report is a pre-emptive measurement report.

In some aspects, based on the updated criteria, the UE 1202 may not send a measurement report that would have been triggered according to the initial criteria. For example, based on the network environment perception information, the UE 1204 may detect presence of an incoming block and predict an RSRP drop and blockage duration. Based on RSRP drop and block duration, the UE 1204 may update the criteria at operation 1212 such that handover is not triggered (e.g., the blockage duration is short and the line-of-sight will quickly be restored). Thus, the UE 1204 may not send a measurement report, at operation 1214, that the UE 1204 would otherwise send based on the initial (not updated) criteria. Thus, the UE 1204 can prevent frequent handover. For example, without network environment perception information, if the UE 1204 sent the measurement report at operation 1214 based on the initial criteria, the serving cell 1202 may then send the RRC Reconfiguration to the UE 1204 at operation 1216 and at operation 1218 the UE 1204 hands over to the target cell 1206. However, once the line-of-sight is restored at the UE 1204 (e.g., after the blocker passes by), another measurement report may be triggered from the UE 1204 to the target cell 1206 at operation 1220. At operation 1222, the UE 1204 then receives the RRC Reconfiguration from the target cell 1206 and hands over back to the previous serving cell 1202 at operation 1224.

According to certain aspects, at operation 1210, the network entity may send the measurement event message, which may, include additional field(s), such as one or more field(s) in the ReportConfigNR IE, that configure the UE to autonomously adjust the criteria. In some examples, the ReportConfigNR IE has the following format including examples of additional fields configuring the UE to autonomously update the A3 event criteria. In some aspects, the measurement event message may include fields configuring the UE to autonomously update the criteria of any measurement event. In addition, in some aspects, the measurement event message, or any examples such as the ReportConfigNR, may include different fields than provided below or have a different format than provided below. Example ReportConfigNR format:

-- ASN1START
-- TAG-REPORTCONFIGNR-START

| | |
|---|---|
| ReportConfigNR ::= | SEQUENCE { |
| reportType | CHOICE { |
| periodical | PeriodicalReportConfig, |
| eventTriggered | EventTriggerConfig |

...

| | |
|---|---|
| CondTriggerConfig-r16 ::= | SEQUENCE { |
| condEventId | CHOICE { |
| condEventA3 | SEQUENCE { |
| a3-Offset | MeasTriggerQuantityOffset, |
| hysteresis | Hysteresis, |
| timeToTrigger | TimeToTrigger |

...

| | |
|---|---|
| EventTriggerConfig::= | SEQUENCE { |

| | |
|---|---|
| eventId | CHOICE { |

| | |
|---|---|
| eventA1 | SEQUENCE { |
| a1-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA2 | SEQUENCE |
| a2-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA3 | SEQUENCE { |
| a3-Offset | MeasTriggerQuantityOffset, |
| reportOnLeave | BOOLEAN, |
| hysteresis | Hysteresis, |
| timeToTrigger | TimeToTrigger, |
| useAllowedCellList | BOOLEAN |

```
          A3-Offset rsrp range: x
          hysteresis range: y
          timeToTrigger range: z
      },
```

| | |
|---|---|
| eventA4 | SEQUENCE { |
| a4-Threshold | MeasTriggerQuantity, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA5 | SEQUENCE { |
| a5-Threshold1 | MeasTriggerQuantity, |
| a5-Threshold2 | MeasTriggerQuantity, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA6 | SEQUENCE { |
| a6-Offset | MeasTriggerQuantityOffset, |
| reportOnLeave | BOOLEAN, |
| hysteresis | Hysteresis, |
| timeToTrigger | TimeToTrigger, |
| useAllowedCellList | BOOLEAN |

```
      },
      ...,
```

| | |
|---|---|
| timeToTrigger-r17 | TimeToTrigger |

...

| | |
|---|---|
| MeasTriggerQuantity ::= | CHOICE { |

| | |
|---|---|
| rsrp | RSRP-Range, |
| rsrq | RSRQ-Range, |
| sinr | SINR-Range |

}

| | |
|---|---|
| MeasTriggerQuantityOffset ::= | CHOICE { |

| | |
|---|---|
| rsrp | INTEGER (−30..30), |
| rsrq | INTEGER (−30..30), |
| sinr | INTEGER (−30..30) |

}

| | |
|---|---|
| MeasReportQuantity ::= | SEQUENCE { |

| | |
|---|---|
| rsrp | BOOLEAN, |
| rsrq | BOOLEAN, |
| sinr | BOOLEAN |

...
-- TAG-REPORTCONFIGNR-STOP
-- ASN1STOP

In the example message format, the field “A3-Offset rsrp range: x” specifies that the UE is allowed to adjust the RSRP offset by plus or minus (+/−) x dB(s). The field “hysteresis range: y” specifies that the UE is allowed to adjust the hysteresis by +/−y dB(s). The field “timeToTrigger range: z” specifies that the UE is allowed to adjust the TTT by +/−z ms.

According to certain aspects, the network entity may send, at operation 1213, the measurement report message, which may include additional field(s) (e.g., a field in the RRC MeasurementReport message) that indicates the measurement report is pre-emptive. In some examples, the MeasurementReport message has the following format (although other examples of the measurement report message, including the RRC MeasurementReport message may include different fields or have a different format):

-- ASN1START
-- TAG-MEASUREMENTREPORT-START

| | |
|---|---|
| MeasurementReport ::= | SEQUENCE { |
| criticalExtensions | CHOICE { |
| measurementReport | MeasurementReport-IEs, |
| criticalExtensionsFuture | SEQUENCE { } |

}
}

| | |
|---|---|
| MeasurementReport-IEs ::= | SEQUENCE { |
| measResults | MeasResults, |

PreemptiveHandover: True

| | | |
|---|---|---|
| lateNonCriticalExtension | OCTET STRING | OPTIONAL, |
| nonCriticalExtension | SEQUENCE{ } | OPTIONAL |

}
-- TAG-MEASUREMENTREPORT-STOP
-- ASN1STOP

In the example message format, the field “PreemptiveHandover: True” indicates that the measurement report is a preemptive measurement report.

The enhanced mobility management may improve handover, for example in both sub-6 GHz and in mmWave. The enhanced mobility management may reduce interruption time, reduce the risk of beam failure, and improve power saving by reducing measurement of nearby cells when handover conditions are unlikely.

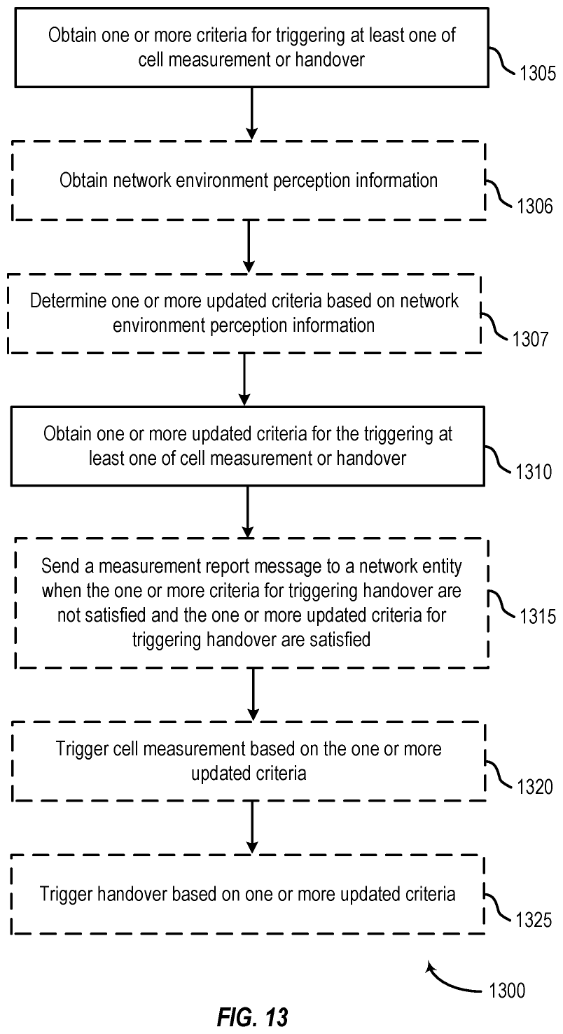

FIG. 13 shows an example of a method 1300 of wireless communications by a user equipment, such as a UE 104 of FIGS. 1 and 3.

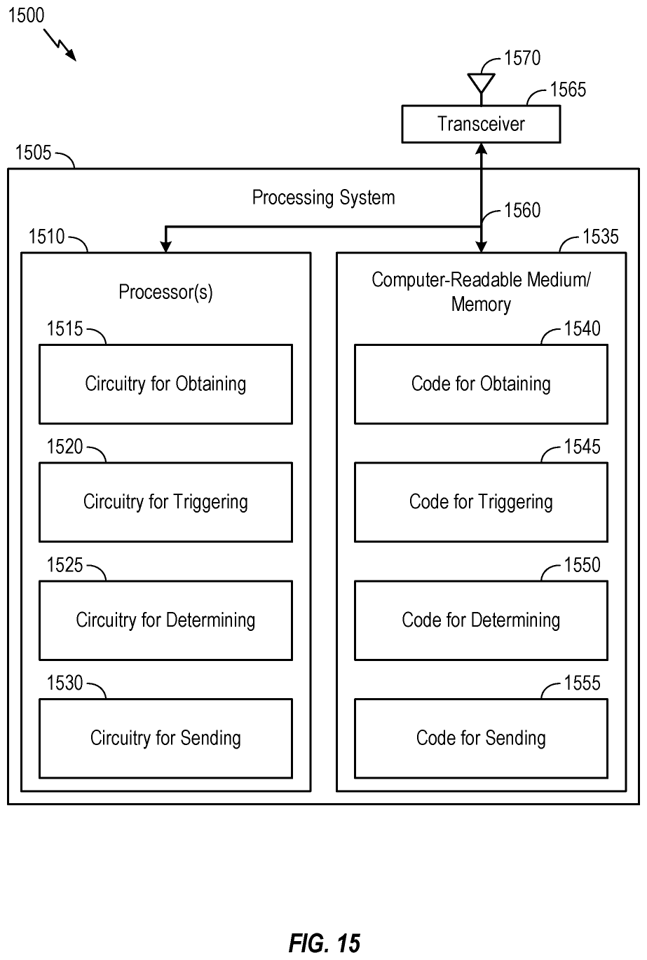

Method 1300 begins at operation 1305 with obtaining one or more criteria for triggering at least one of cell measurement or handover. In some cases, the operations of this step refer to, or may be performed by, circuitry for obtaining and/or code for obtaining as described with reference to FIG. 15. For example, the obtaining may be as shown at operation 1008 in FIG. 10, operation 1210 in FIG. 12, and may be via a measurement event message, such as the RRC ReportConfigNR IE.

Method 1300 then proceeds to operation 1310 with obtaining one or more updated criteria for the triggering at least one of cell measurement or handover. In some cases, the operations of this step refer to, or may be performed by, circuitry for obtaining and/or code for obtaining as described with reference to FIG. 15. For example, the obtaining may be as shown at operation 1012 in FIG. 10, operation 1212 in FIG. 12, and may be via another measurement event message, such as the RRC ReportConfigNR IE, or autonomous.

In some aspects, obtaining the one or more updated criteria for triggering at least one of cell measurement or handover at operation 1310 comprises receiving the one or more updated criteria from a network entity. In some aspects, receiving the one or more updated criteria from the network entity at operation 1310 comprises receiving the one or more updated criteria from the network entity in a medium access control (MAC) control element, downlink control information (DCI), or a combination thereof. In some aspects, receiving the one or more updated criteria from the network entity at operation 1310 comprises receiving the one or more updated criteria from the network entity in a radio resource control (RRC) message.

In some aspects, obtaining the one or more criteria for triggering at least one of cell measurement or handover at operation 1305 comprises receiving a first measurement event RRC message from the network entity, and wherein receiving the one or more updated criteria from the network entity at operation 1310 comprises receiving a second measurement event RRC message from the network entity.

In some aspects, obtaining the one or more updated criteria for the triggering at least one of cell measurement or handover at operation 1310 comprises at operation 1307 determining the one or more updated criteria based on network environment perception information.

In some aspects, obtaining one or more criteria for triggering at least one of cell measurement or handover at operation 1305 comprises receiving the one or more criteria from a network entity in a measurement event radio resource control (RRC) message, wherein the measurement event RRC message includes an indication that configures the user equipment to autonomously adjust the one or more criteria.

In some aspects, the method 1300 further includes at operation 1315 sending a measurement report message to a network entity when the one or more criteria for triggering handover are not satisfied and the one or more updated criteria for triggering handover are satisfied. In some cases, the operations of this step refer to, or may be performed by, circuitry for sending and/or code for sending as described with reference to FIG. 15.

In some aspects, the measurement report message comprises a field indicating the measurement report message is a pre-emptive measurement report message.

In some aspects, obtaining the one or more updated criteria for the triggering at least one of cell measurement or handover at operation 1310 comprises: sending a message to a network entity to suggest the determined one or more updated criteria; and receiving the one or more updated criteria from the network entity in response to the message suggesting the one or more updated criteria.

In some aspects, obtaining one or more criteria for triggering at least one of cell measurement or handover at operation 1305 comprises receiving the one or more criteria from the network entity in a measurement event radio resource control (RRC) message, wherein the measurement event RRC message includes an indication that configures the user equipment to suggest the one or more updated criteria.

In some aspects, the one or more criteria comprises a first reference signal received power (RSRP) offset threshold between a serving cell signal quality and a neighboring cell signal quality for triggering a handover from a serving cell to the neighboring cell, and wherein the one or more updated criteria comprises a second RSRP offset threshold between the serving cell signal quality and the neighboring cell signal quality for triggering the handover from the serving cell to the neighboring cell. In some aspects, the one or more criteria comprises a first time-to-trigger (TTT) duration threshold that an RSRP offset between the serving cell signal quality and the neighboring cell signal quality satisfies the RSRP offset threshold for triggering the handover from the serving cell to the neighboring cell, and wherein the one or more updated criteria comprises a second TTT duration threshold that the RSRP offset between the serving cell signal quality and the neighboring cell signal quality satisfies the RSRP offset threshold for triggering the handover from the serving cell to the neighboring cell. In some aspects, the one or more criteria comprises a first signal quality threshold for initiating or increasing periodicity of intra-cell measurements, and wherein the one or more updated criteria comprises a second signal quality threshold for initiating or increasing the periodicity of intra-cell measurements. In some aspects, the one or more criteria comprises a first signal quality threshold for stopping or decreasing periodicity of intra-cell measurements, and wherein the one or more updated criteria comprises a second signal quality threshold for stopping or decreasing the periodicity of intra-cell measurements. In some aspects, the one or more criteria comprises a first signal quality threshold for initiating or increasing periodicity of inter-cell measurements, and wherein the one or more updated criteria comprises a second signal quality threshold for initiating or increasing the periodicity of inter-cell measurements. In some aspects, the one or more criteria comprises a first signal quality threshold for stopping or decreasing periodicity of inter-cell measurements, and wherein the one or more updated criteria comprises a second signal quality threshold for stopping or decreasing the periodicity of inter-cell measurements. In some aspects, the one or more updated criteria comprises an updated hysteresis range, an updated A1 measurement event criteria, an updated A2 measurement event criteria, an updated A3 measurement event criteria, an updated A4 measurement event criteria, an updated A5 measurement event criteria, an updated A6 measurement event criteria, or a combination thereof.

In some aspects, the method 1300 further includes at operation 1306 obtaining network environment perception information. In some cases, the operations of this step refer to, or may be performed by, circuitry for obtaining and/or code for obtaining as described with reference to FIG. 15.

In some aspects, the network environment perception information comprises a position of the user equipment, an orientation of the user equipment, detection of an object blocking a link between the user equipment and a network entity, a speed of the user equipment, a direction of the user equipment, a radio frequency (RF) mapping, or a combination thereof.

In some aspects, obtaining the network environment perception information at operation 1306 comprises collecting the network environment perception information via one or more sensors of the user equipment. In some aspects, one or more sensors includes one or more cameras, an inertial measurement unit (IMU), or a combination thereof.

In some aspects, the method 1300 further includes providing the network environment perception information to a network entity. In some cases, the operations of this step refer to, or may be performed by, circuitry for providing and/or code for providing as described with reference to FIG. 15.

In some aspects, obtaining the network environment perception information comprising receiving the network environment perception information from a network entity.

In some aspects, the method 1300 further includes at operation 1320 triggering cell measurement based on the one or more updated criteria. In some cases, the operations of this step refer to, or may be performed by, circuitry for triggering and/or code for triggering as described with reference to FIG. 15.

In some aspects, the method 1300 further includes at operation 1325 triggering handover based on the one or more updated criteria. In some cases, the operations of this step refer to, or may be performed by, circuitry for triggering and/or code for triggering as described with reference to FIG. 15.

In one aspect, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative steps are possible consistent with this disclosure.

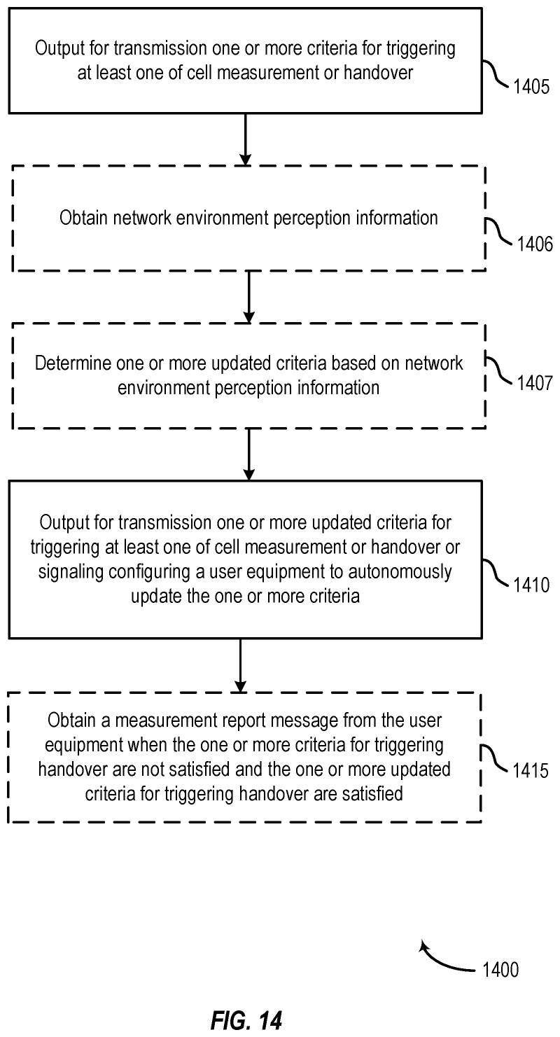

FIG. 14 shows an example of a method 1400 of wireless communications by a network entity, such as a BS 102 of FIGS. 1 and 3, or a disaggregated base station as discussed with respect to FIG. 2.

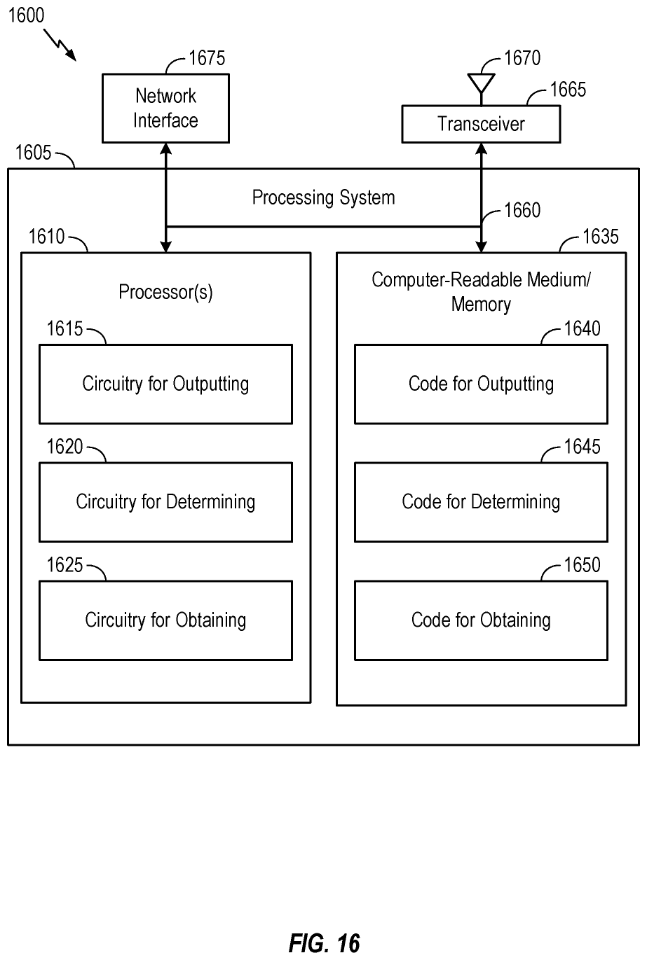

Method 1400 begins at operation 1405 with outputting a transmission one or more criteria associated with triggering at least one of cell measurement or handover. In some cases, the operations of this step refer to, or may be performed by, circuitry for outputting and/or code for outputting as described with reference to FIG. 16. For example, the outputting may be as shown at operation 1008 in FIG. 10, operation 1210 in FIG. 12, and may be via a measurement event message, such as the RRC ReportConfigNR IE.

Method 1400 then proceeds to operation 1410 with outputting for transmission one or more updated criteria associated with the triggering at least one of cell measurement or handover based at least in part on network environment perception information or signaling configuring a user equipment to autonomously update the one or more criteria based at least in part on network environment perception information. In some cases, the operations of this step refer to, or may be performed by, circuitry for outputting and/or code for outputting as described with reference to FIG. 16. For example, the outputting may be as shown at operation 1012 in FIG. 10, operation 1210 in FIG. 12, and may be via a measurement event message, such as the RRC ReportConfigNR IE.

In some aspects, outputting for transmission the one or more updated criteria for triggering at least one of cell measurement or handover or handover or signaling configuring the user equipment to autonomously update the one or more criteria at operation 1410 comprises outputting for transmission the one or more updated criteria. In some aspects, outputting for transmission the one or more updated criteria at operation 1410 comprises outputting for transmission the one or more updated criteria in a medium access control (MAC) control element, downlink control information (DCI), or a combination thereof. In some aspects, outputting for transmission the one or more updated criteria at operation 1410 comprises outputting for transmission the one or more updated criteria in a radio resource control (RRC) message.

In some aspects, outputting for transmission the one or more criteria for triggering at least one of cell measurement or handover at operation 1405 comprises outputting for transmission a first measurement event RRC message to the user equipment, and wherein outputting for transmission the one or more updated criteria at operation 1410 comprises outputting for transmission a second measurement event RRC message to the user equipment.

In some aspects, the method 1400 further includes, at operation 1407, determining the one or more updated criteria based on network environment perception information. In some cases, the operations of this step refer to, or may be performed by, circuitry for determining and/or code for determining as described with reference to FIG. 16.

In some aspects, outputting for transmission the one or more updated criteria for triggering at least one of cell measurement or handover or handover or signaling configuring the user equipment to autonomously update the one or more criteria at operation 1410 comprises outputting for transmission signaling configuring the user equipment to autonomously update the one or more criteria.

In some aspects, outputting for transmission signaling configuring the user equipment to autonomously update the one or more criteria at operation 1410 comprises outputting for transmission the signaling configuring the user equipment to autonomously update the one or more criteria in a measurement event radio resource control (RRC) message.

In some aspects, the method 1400 further includes at operation 1415 obtaining a measurement report message from the user equipment when the one or more criteria for triggering handover are not satisfied and the one or more updated criteria for trigger handover are satisfied. In some cases, the operations of this step refer to, or may be performed by, circuitry for obtaining and/or code for obtaining as described with reference to FIG. 16.

In some aspects, the measurement report message comprises a field indicating the measurement report message is a pre-emptive measurement report message.

In some aspects, the method 1400 further includes obtaining a message from the user equipment indicating suggested one or more updated criteria. In some cases, the operations of this step refer to, or may be performed by, circuitry for obtaining and/or code for obtaining as described with reference to FIG. 16.

In some aspects, the method 1400 further includes outputting for transmission to the user equipment the one or more updated criteria in response to the message suggesting the one or more updated criteria. In some cases, the operations of this step refer to, or may be performed by, circuitry for outputting and/or code for outputting as described with reference to FIG. 16.

In some aspects, outputting for transmission the one or more criteria for triggering at least one of cell measurement or handover at operation 1405 comprises outputting for transmission the one or more criteria in a measurement event radio resource control (RRC) message, wherein the measurement event RRC message includes an indication that configures the user equipment to suggest the one or more updated criteria.

In some aspects, the one or more criteria comprises a first reference signal received power (RSRP) offset threshold between a serving cell signal quality and a neighboring cell signal quality for triggering a handover from a serving cell to the neighboring cell, and wherein the one or more updated criteria comprises a second RSRP offset threshold between the serving cell signal quality and the neighboring cell signal quality for triggering the handover from the serving cell to the neighboring cell. In some aspects, the one or more criteria comprises a first time-to-trigger (TTT) duration threshold that an RSRP offset between the serving cell signal quality and the neighboring cell signal quality satisfies the RSRP offset threshold for triggering the handover from the serving cell to the neighboring cell, and wherein the one or more updated criteria comprises a second TTT duration threshold that the RSRP offset between the serving cell signal quality and the neighboring cell signal quality satisfies the RSRP offset threshold for triggering the handover from the serving cell to the neighboring cell. In some aspects, the one or more criteria comprises a first signal quality threshold for initiating or increasing periodicity of intra-cell measurements, and wherein the one or more updated criteria comprises a second signal quality threshold for initiating or increasing the periodicity of intra-cell measurements. In some aspects, the one or more criteria comprises a first signal quality threshold for stopping or decreasing periodicity of intra-cell measurements, and wherein the one or more updated criteria comprises a second signal quality threshold for stopping or decreasing the periodicity of intra-cell measurements. In some aspects, the one or more criteria comprises a first signal quality threshold for initiating or increasing periodicity of inter-cell measurements, and wherein the one or more updated criteria comprises a second signal quality threshold for initiating or increasing the periodicity of inter-cell measurements. In some aspects, the one or more criteria comprises a first signal quality threshold for stopping or decreasing periodicity of inter-cell measurements, and wherein the one or more updated criteria comprises a second signal quality threshold for stopping or decreasing the periodicity of inter-cell measurements. In some aspects, the one or more updated criteria comprises an updated hysteresis range, an updated A1 measurement event criteria, an updated A2 measurement event criteria, an updated A3 measurement event criteria, an updated A4 measurement event criteria, an updated A5 measurement event criteria, an updated A6 measurement event criteria, or a combination thereof.

In some aspects, the method 1400 further includes at operation 1406 obtaining network environment perception information. In some cases, the operations of this step refer to, or may be performed by, circuitry for obtaining and/or code for obtaining as described with reference to FIG. 16.

In some aspects, the network environment perception information comprises a position of the user equipment, an orientation of the user equipment, detection of an object blocking a link between the user equipment and the network entity, a speed of the user equipment, a direction of the user equipment, a radio frequency (RF) mapping, or a combination thereof.

In some aspects, obtaining the network environment perception information at operation 1406 comprises collecting the network environment perception information via one or more sensors of the network entity. In some aspects, one or more sensors includes one or more cameras, an inertial measurement unit (IMU), or a combination thereof.

In some aspects, the method 1400 further includes providing the network environment perception information to the user equipment. In some cases, the operations of this step refer to, or may be performed by, circuitry for providing and/or code for providing as described with reference to FIG. 16.

In some aspects, obtaining the network environment perception information at operation 1406 comprising receiving the network environment perception information from the user equipment.

In one aspect, method 1400, or any aspect related to it, may be performed by an apparatus, such as communications device 1600 of FIG. 16, which includes various components operable, configured, or adapted to perform the method 1400. Communications device 1600 is described below in further detail.

Note that FIG. 14 is just one example of a method, and other methods including fewer, additional, or alternative steps are possible consistent with this disclosure.

FIG. 15 depicts aspects of an example communications device 1500. In some aspects, communications device 1500 is a user equipment, such as UE 104 described above with respect to FIGS. 1 and 3.

The communications device 1500 includes a processing system 1505 coupled to the transceiver 1565 (e.g., a transmitter and/or a receiver). The transceiver 1565 is configured to transmit and receive signals for the communications device 1500 via the antenna 1570, such as the various signals as described herein. The processing system 1505 may be configured to perform processing functions for the communications device 1500, including processing signals received and/or to be transmitted by the communications device 1500.

The processing system 1505 includes one or more processors 1510. In various aspects, the one or more processors 1510 may be representative of one or more of receive processor 358, transmit processor 364, TX MIMO processor 366, and/or controller/processor 380, as described with respect to FIG. 3. The one or more processors 1510 are coupled to a computer-readable medium/memory 1535 via a bus 1560. In certain aspects, the computer-readable medium/memory 1535 is configured to store instructions (e.g., computer-executable code) that when executed by the one or more processors 1510, cause the one or more processors 1510 to perform the method 1300 described with respect to FIG. 13, or any aspect related to it. Note that reference to a processor performing a function of communications device 1500 may include one or more processors 1510 performing that function of communications device 1500.

In the depicted example, computer-readable medium/memory 1535 stores code (e.g., executable instructions), such as code for obtaining 1540, code for triggering 1545, code for determining 1550, and code for sending 1555. Processing of the code for obtaining 1540, code for triggering 1545, code for determining 1550, and code for sending 1555 may cause the communications device 1500 to perform the method 1300 described with respect to FIG. 13, or any aspect related to it.

The one or more processors 1510 include circuitry configured to implement (e.g., execute) the code stored in the computer-readable medium/memory 1535, including circuitry such as circuitry for obtaining 1515, circuitry for triggering 1520, circuitry for determining 1525, and circuitry for sending 1530. Processing with circuitry for obtaining 1515, circuitry for triggering 1520, circuitry for determining 1525, and circuitry for sending 1530 may cause the communications device 1500 to perform the method 1300 described with respect to FIG. 13, or any aspect related to it.

Various components of the communications device 1500 may provide means for performing the method 1300 described with respect to FIG. 13, or any aspect related to it. For example, means for transmitting, sending or outputting for transmission may include transceivers 354 and/or antenna(s) 352 of the UE 104 illustrated in FIG. 3 and/or the transceiver 1565 and the antenna 1570 of the communications device 1500 in FIG. 15. Means for receiving or obtaining may include transceivers 354 and/or antenna(s) 352 of the UE 104 illustrated in FIG. 3 and/or the transceiver 1565 and the antenna 1570 of the communications device 1500 in FIG. 15.

FIG. 16 depicts aspects of an example communications device 1600. In some aspects, communications device 1600 is a network entity, such as BS 102 of FIGS. 1 and 3, or a disaggregated base station as discussed with respect to FIG. 2.

The communications device 1600 includes a processing system 1605 coupled to the transceiver 1665 (e.g., a transmitter and/or a receiver) and/or a network interface 1675. The transceiver 1665 is configured to transmit and receive signals for the communications device 1600 via the antenna 1670, such as the various signals as described herein. The network interface 1675 is configured to obtain and send signals for the communications device 1600 via communication link(s), such as a backhaul link, midhaul link, and/or fronthaul link as described herein, such as with respect to FIG. 2. The processing system 1605 may be configured to perform processing functions for the communications device 1600, including processing signals received and/or to be transmitted by the communications device 1600.

The processing system 1605 includes one or more processors 1610. In various aspects, one or more processors 1610 may be representative of one or more of receive processor 338, transmit processor 320, TX MIMO processor 330, and/or controller/processor 340, as described with respect to FIG. 3. The one or more processors 1610 are coupled to a computer-readable medium/memory 1635 via a bus 1660. In certain aspects, the computer-readable medium/memory 1635 is configured to store instructions (e.g., computer-executable code) that when executed by the one or more processors 1610, cause the one or more processors 1610 to perform the method 1400 described with respect to FIG. 14, or any aspect related to it. Note that reference to a processor of communications device 1600 performing a function may include one or more processors 1610 of communications device 1600 performing that function.

In the depicted example, the computer-readable medium/memory 1635 stores code (e.g., executable instructions), such as code for outputting 1640, code for determining 1645, and code for obtaining 1650. Processing of the code for outputting 1640, code for determining 1645, and code for obtaining 1650, may cause the communications device 1600 to perform the method 1400 described with respect to FIG. 14, or any aspect related to it.

The one or more processors 1610 include circuitry configured to implement (e.g., execute) the code stored in the computer-readable medium/memory 1635, including circuitry such as circuitry for outputting 1615, circuitry for determining 1620, and circuitry for obtaining 1625. Processing with circuitry for outputting 1615, circuitry for determining 1620, and circuitry for obtaining 1625 may cause the communications device 1600 to perform the method 1400 described with respect to FIG. 14, or any aspect related to it.

Various components of the communications device 1600 may provide means for performing the method 1400 described with respect to FIG. 14, or any aspect related to it. Means for transmitting, sending or outputting for transmission may include transceivers 332 and/or antenna(s) 334 of the BS 102 illustrated in FIG. 3 and/or the transceiver 1665 and the antenna 1670 of the communications device 1600 in FIG. 16. Means for receiving or obtaining may include transceivers 332 and/or antenna(s) 334 of the BS 102 illustrated in FIG. 3 and/or the transceiver 1665 and the antenna 1670 of the communications device 1600 in FIG. 16.

Implementation examples are described in the following numbered clauses:

Clause 1: A method of wireless communications by a user equipment, comprising: obtaining one or more criteria associated with triggering at least one of cell measurement or handover; and obtaining one or more updated criteria associated with the triggering at least one of cell measurement or handover. The one or more updated criteria may be based at least in part on network environment perception information.

Clause 2: The method of Clause 1, further comprising triggering cell measurement based on the one or more updated criteria.

Clause 3: The method of any combination of Clauses 1-2, further comprising triggering handover based on the one or more updated criteria.

Clause 4: The method of any combination of Clauses 1-3, wherein obtaining the one or more updated criteria for triggering at least one of cell measurement or handover comprises receiving the one or more updated criteria from a network entity.

Clause 5: The method of Clause 4, wherein receiving the one or more updated criteria from the network entity comprises receiving the one or more updated criteria from the network entity in a medium access control (MAC) control element, downlink control information (DCI), or a combination thereof.

Clause 6: The method of any combination of Clauses 4-5, wherein receiving the one or more updated criteria from the network entity comprises receiving the one or more updated criteria from the network entity in a radio resource control (RRC) message.

Clause 7: The method of Clause 6, wherein obtaining the one or more criteria for triggering at least one of cell measurement or handover comprises receiving a first measurement event RRC message from the network entity, and wherein receiving the one or more updated criteria from the network entity comprises receiving a second measurement event RRC message from the network entity.

Clause 8: The method of any combination of Clauses 1-7, wherein obtaining the one or more updated criteria for the triggering at least one of cell measurement or handover comprises determining the one or more criteria based on the network environment perception information.

Clause 9: The method of Clause 8, wherein obtaining one or more criteria for triggering at least one of cell measurement or handover comprises receiving the one or more criteria from a network entity in a measurement event radio resource control (RRC) message, wherein the measurement event RRC message includes an indication that configures the user equipment to autonomously adjust the one or more criteria.

Clause 10: The method of any combination of Clauses 8-9, further comprising sending a measurement report message to a network entity when the one or more criteria for triggering handover are not satisfied and the one or more updated criteria for trigger handover are satisfied.

Clause 11: The method of Clause 10, wherein the measurement report message comprises a field indicating the measurement report message is a pre-emptive measurement report message.

Clause 12: The method of any combination of Clauses 8-11, wherein obtaining the one or more updated criteria for the triggering at least one of cell measurement or handover comprises: sending a message to a network entity to suggest the determined one or more updated criteria; and receiving the one or more updated criteria from the network entity in response to the message suggesting the one or more updated criteria.

Clause 13: The method of Clause 12, wherein obtaining one or more criteria for triggering at least one of cell measurement or handover comprises receiving the one or more criteria from the network entity in a measurement event radio resource control (RRC) message, wherein the measurement event RRC message includes an indication that configures the user equipment to suggest the one or more updated criteria.

Clause 14: The method of any combination of Clauses 1-13, wherein the one or more criteria comprises a first reference signal received power (RSRP) offset threshold between a serving cell signal quality and a neighboring cell signal quality for triggering a handover from a serving cell to the neighboring cell, and wherein the one or more updated criteria comprises a second RSRP offset threshold between the serving cell signal quality and the neighboring cell signal quality for triggering the handover from the serving cell to the neighboring cell.

Clause 15: The method of Clause 14, wherein the one or more criteria comprises a first time-to-trigger (TTT) duration threshold that an RSRP offset between the serving cell signal quality and the neighboring cell signal quality satisfies the RSRP offset threshold for triggering the handover from the serving cell to the neighboring cell, and wherein the one or more updated criteria comprises a second TTT duration threshold that the RSRP offset between the serving cell signal quality and the neighboring cell signal quality satisfies the RSRP offset threshold for triggering the handover from the serving cell to the neighboring cell.

Clause 16: The method of any combination of Clauses 1-15, wherein the one or more criteria comprises a first signal quality threshold for initiating or increasing periodicity of intra-cell measurements, and wherein the one or more updated criteria comprises a second signal quality threshold for initiating or increasing the periodicity of intra-cell measurements.

Clause 17: The method of any combination of Clauses 1-16, wherein the one or more criteria comprises a first signal quality threshold for stopping or decreasing periodicity of intra-cell measurements, and wherein the one or more updated criteria comprises a second signal quality threshold for stopping or decreasing the periodicity of intra-cell measurements.

Clause 18: The method of any combination of Clauses 1-17, wherein the one or more criteria comprises a first signal quality threshold for initiating or increasing periodicity of inter-cell measurements, and wherein the one or more updated criteria comprises a second signal quality threshold for initiating or increasing the periodicity of inter-cell measurements.

Clause 19: The method of any combination of Clauses 1-18, wherein the one or more criteria comprises a first signal quality threshold for stopping or decreasing periodicity of inter-cell measurements, and wherein the one or more updated criteria comprises a second signal quality threshold for stopping or decreasing the periodicity of inter-cell measurements.

Clause 20: The method of any combination of Clauses 1-19, wherein the one or more updated criteria comprises an updated hysteresis range, an updated A1 measurement event criteria, an updated A2 measurement event criteria, an updated A3 measurement event criteria, an updated A4 measurement event criteria, an updated A5 measurement event criteria, an updated A6 measurement event criteria, or a combination thereof.

Clause 21: The method of any combination of Clauses 1-20, further comprising obtaining the network environment perception information.

Clause 22: The method of Clause 21, wherein the network environment perception information comprises a position of the user equipment, an orientation of the user equipment, detection of an object blocking a link between the user equipment and a network entity, a speed of the user equipment, a direction of the user equipment, a radio frequency (RF) mapping, or a combination thereof.

Clause 23: The method of any combination of Clauses 21-22, wherein obtaining the network environment perception information comprises collecting the network environment perception information via one or more sensors of the user equipment.

Clause 24: The method of Clause 23, wherein one or more sensors includes one or more cameras, an inertial measurement unit (IMU), or a combination thereof.

Clause 25: The method of any combination of Clauses 21-24, further comprising providing the network environment perception information to a network entity.

Clause 26: The method of any combination of Clauses 21-25, wherein obtaining the network environment perception information comprising receiving the network environment perception information from a network entity.

Clause 27: A method of wireless communications by a network entity, comprising: outputting for transmission one or more criteria associated with triggering at least one of cell measurement or handover; and outputting for transmission one or more updated criteria associated with the triggering at least one of cell measurement or handover based at least in part on network environment perception information or signaling configuring a user equipment to autonomously update the one or more criteria based at least in part on network environment perception information.

Clause 28: The method of Clause 27, wherein outputting for transmission the one or more updated criteria for triggering at least one of cell measurement or handover or handover or signaling configuring the user equipment to autonomously update the one or more criteria comprises outputting for transmission the one or more updated criteria.

Clause 29: The method of Clause 28, wherein outputting for transmission the one or more updated criteria comprises outputting for transmission the one or more updated criteria in a medium access control (MAC) control element, downlink control information (DCI), or a combination thereof.

Clause 30: The method of any combination of Clauses 28-29, wherein outputting for transmission the one or more updated criteria comprises outputting for transmission the one or more updated criteria in a radio resource control (RRC) message.

Clause 31: The method of Clause 30, wherein outputting for transmission the one or more criteria for triggering at least one of cell measurement or handover comprises outputting for transmission a first measurement event RRC message to the user equipment, and wherein outputting for transmission the one or more updated criteria comprises outputting for transmission a second measurement event RRC message to the user equipment.

Clause 32: The method of any combination of Clauses 28-31, further comprising determining the one or more updated criteria based on the network environment perception information.

Clause 33: The method of any combination of Clauses 27-32, wherein outputting for transmission the one or more updated criteria for triggering at least one of cell measurement or handover or handover or signaling configuring the user equipment to autonomously update the one or more criteria comprises outputting for transmission signaling configuring the user equipment to autonomously update the one or more criteria.

Clause 34: The method of Clause 33, wherein outputting for transmission signaling configuring the user equipment to autonomously update the one or more criteria comprises outputting for transmission the signaling configuring the user equipment to autonomously update the one or more criteria in a measurement event radio resource control (RRC) message.

Clause 35: The method of any combination of Clauses 33-34, further comprising obtaining a measurement report message from the user equipment when the one or more criteria for triggering handover are not satisfied and the one or more updated criteria for trigger handover are satisfied.

Clause 36: The method of Clause 35, wherein the measurement report message comprises a field indicating the measurement report message is a pre-emptive measurement report message.

Clause 37: The method of any combination of Clauses 27-36, further comprising: obtaining a message from the user equipment indicating suggested one or more updated criteria; and outputting for transmission to the user equipment the one or more updated criteria in response to the message suggesting the one or more updated criteria.

Clause 38: The method of Clause 37, wherein outputting for transmission the one or more criteria for triggering at least one of cell measurement or handover comprises outputting for transmission the one or more criteria in a measurement event radio resource control (RRC) message, wherein the measurement event RRC message includes an indication that configures the user equipment to suggest the one or more updated criteria.

Clause 39: The method of any combination of Clauses 27-38, wherein the one or more criteria comprises a first reference signal received power (RSRP) offset threshold between a serving cell signal quality and a neighboring cell signal quality for triggering a handover from a serving cell to the neighboring cell, and wherein the one or more updated criteria comprises a second RSRP offset threshold between the serving cell signal quality and the neighboring cell signal quality for triggering the handover from the serving cell to the neighboring cell.

Clause 40: The method of Clause 39, wherein the one or more criteria comprises a first time-to-trigger (TTT) duration threshold that an RSRP offset between the serving cell signal quality and the neighboring cell signal quality satisfies the RSRP offset threshold for triggering the handover from the serving cell to the neighboring cell, and wherein the one or more updated criteria comprises a second TTT duration threshold that the RSRP offset between the serving cell signal quality and the neighboring cell signal quality satisfies the RSRP offset threshold for triggering the handover from the serving cell to the neighboring cell.

Clause 41: The method of any combination of Clauses 27-40, wherein the one or more criteria comprises a first signal quality threshold for initiating or increasing periodicity of intra-cell measurements, and wherein the one or more updated criteria comprises a second signal quality threshold for initiating or increasing the periodicity of intra-cell measurements.

Clause 42: The method of any combination of Clauses 27-41, wherein the one or more criteria comprises a first signal quality threshold for stopping or decreasing periodicity of intra-cell measurements, and wherein the one or more updated criteria comprises a second signal quality threshold for stopping or decreasing the periodicity of intra-cell measurements.

Clause 43: The method of any combination of Clauses 27-42, wherein the one or more criteria comprises a first signal quality threshold for initiating or increasing periodicity of inter-cell measurements, and wherein the one or more updated criteria comprises a second signal quality threshold for initiating or increasing the periodicity of inter-cell measurements.

Clause 44: The method of any combination of Clauses 27-43, wherein the one or more criteria comprises a first signal quality threshold for stopping or decreasing periodicity of inter-cell measurements, and wherein the one or more updated criteria comprises a second signal quality threshold for stopping or decreasing the periodicity of inter-cell measurements.

Clause 45: The method of any combination of Clauses 27-44, wherein the one or more updated criteria comprises an updated hysteresis range, an updated A1 measurement event criteria, an updated A2 measurement event criteria, an updated A3 measurement event criteria, an updated A4 measurement event criteria, an updated A5 measurement event criteria, an updated A6 measurement event criteria, or a combination thereof.

Clause 46: The method of any combination of Clauses 27-45, further comprising obtaining the network environment perception information.

Clause 47: The method of Clause 46, wherein the network environment perception information comprises a position of the user equipment, an orientation of the user equipment, detection of an object blocking a link between the user equipment and the network entity, a speed of the user equipment, a direction of the user equipment, a radio frequency (RF) mapping, or a combination thereof.

Clause 48: The method of Clause 46, wherein obtaining the network environment perception information comprises collecting the network environment perception information via one or more sensors of the network entity.

Clause 49: The method of Clause 48, wherein one or more sensors includes one or more cameras, an inertial measurement unit (IMU), or a combination thereof.

Clause 50: The method of any combination of Clauses 46-49, further comprising providing the network environment perception information to the user equipment.

Clause 51: The method of any combination of Clauses 46-50, wherein obtaining the network environment perception information comprising receiving the network environment perception information from the user equipment.

Clause 52: An apparatus, comprising: a memory comprising executable instructions; and a processor configured to execute the executable instructions and cause the apparatus to perform a method in accordance with any one of Clauses 1-51.

Clause 53: An apparatus, comprising means for performing a method in accordance with any one of Clauses 1-51.

Clause 54: A non-transitory computer-readable medium comprising executable instructions that, when executed by a processor of an apparatus, cause the apparatus to perform a method in accordance with any one of Clauses 1-51.

Clause 55: A computer program product embodied on a computer-readable storage medium comprising code for performing a method in accordance with any one of Clauses 1-51.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of wireless communications by a user equipment, the method comprising:
obtaining one or more criteria associated with triggering at least one of cell measurement or handover; and
obtaining one or more updated criteria associated with the triggering at least one of cell measurement or handover, wherein the one or more updated criteria are based at least in part on network environment perception information.

2. The method of claim 1, further comprising triggering cell measurement based on the one or more updated criteria.

3. The method of claim 1, further comprising triggering handover based on the one or more updated criteria.

4. The method of claim 1, wherein obtaining the one or more updated criteria for triggering at least one of cell measurement or handover comprises receiving the one or more updated criteria from a network entity.

5. The method of claim 4, wherein receiving the one or more updated criteria from the network entity comprises receiving the one or more updated criteria from the network entity in a medium access control (MAC) control element, downlink control information (DCI), or a combination thereof.

6. The method of claim 4, wherein receiving the one or more updated criteria from the network entity comprises receiving the one or more updated criteria from the network entity in a radio resource control (RRC) message.

7. The method of claim 6, wherein obtaining the one or more criteria for triggering at least one of cell measurement or handover comprises receiving a first measurement event RRC message from the network entity, and wherein receiving the one or more updated criteria from the network entity comprises receiving a second measurement event RRC message from the network entity.

8. The method of claim 1, wherein obtaining the one or more updated criteria for the triggering at least one of cell measurement or handover comprises determining the one or more updated criteria based on the network environment perception information.

9. The method of claim 8, wherein obtaining one or more criteria for triggering at least one of cell measurement or handover comprises receiving the one or more criteria from a network entity in a measurement event radio resource control (RRC) message, wherein the measurement event RRC message includes an indication that configures the user equipment to autonomously adjust the one or more criteria.

10. The method of claim 8, further comprising sending a measurement report message to a network entity when the one or more criteria for triggering handover are not satisfied and the one or more updated criteria for trigger handover are satisfied.

11. The method of claim 10, wherein the measurement report message comprises a field indicating the measurement report message is a pre-emptive measurement report message.

12. The method of claim 8, wherein obtaining the one or more updated criteria for the triggering at least one of cell measurement or handover comprises:
sending a message to a network entity to suggest the determined one or more updated criteria; and
receiving the one or more updated criteria from the network entity in response to the message suggesting the one or more updated criteria.

13. The method of claim 12, wherein obtaining one or more criteria for triggering at least one of cell measurement or handover comprises receiving the one or more criteria from the network entity in a measurement event radio resource control (RRC) message, wherein the measurement event RRC message includes an indication that configures the user equipment to suggest the one or more updated criteria.

14. The method of claim 1, wherein the one or more criteria comprises a first reference signal received power (RSRP) offset threshold between a serving cell signal quality and a neighboring cell signal quality for triggering a handover from a serving cell to the neighboring cell, and wherein the one or more updated criteria comprises a second RSRP offset threshold between the serving cell signal quality and the neighboring cell signal quality for triggering the handover from the serving cell to the neighboring cell.

15. The method of claim 14, wherein the one or more criteria comprises a first time-to-trigger (TTT) duration threshold that an RSRP offset between the serving cell signal quality and the neighboring cell signal quality satisfies the RSRP offset threshold for triggering the handover from the serving cell to the neighboring cell, and wherein the one or more updated criteria comprises a second TTT duration threshold that the RSRP offset between the serving cell signal quality and the neighboring cell signal quality satisfies the RSRP offset threshold for triggering the handover from the serving cell to the neighboring cell.

16. The method of claim 1, wherein the one or more criteria comprises a first signal quality threshold for initiating or increasing periodicity of intra-cell measurements, and wherein the one or more updated criteria comprises a second signal quality threshold for initiating or increasing the periodicity of intra-cell measurements.

17. The method of claim 1, wherein the one or more criteria comprises a first signal quality threshold for stopping or decreasing periodicity of intra-cell measurements, and wherein the one or more updated criteria comprises a second signal quality threshold for stopping or decreasing the periodicity of intra-cell measurements.

18. The method of claim 1, wherein the one or more criteria comprises a first signal quality threshold for initiating or increasing periodicity of inter-cell measurements, and wherein the one or more updated criteria comprises a second signal quality threshold for initiating or increasing the periodicity of inter-cell measurements.

19. The method of claim 1, wherein the one or more criteria comprises a first signal quality threshold for stopping or decreasing periodicity of inter-cell measurements, and wherein the one or more updated criteria comprises a second signal quality threshold for stopping or decreasing the periodicity of inter-cell measurements.

20. The method of claim 1, wherein the one or more updated criteria comprises an updated hysteresis range, an updated A1 measurement event criteria, an updated A2 measurement event criteria, an updated A3 measurement event criteria, an updated A4 measurement event criteria, an updated A5 measurement event criteria, an updated A6 measurement event criteria, or a combination thereof.

21. The method of claim 1, further comprising obtaining the network environment perception information.

22. The method of claim 21, wherein the network environment perception information comprises a position of the user equipment, an orientation of the user equipment, detection of an object blocking a link between the user equipment and a network entity, a speed of the user equipment, a direction of the user equipment, a radio frequency (RF) mapping, or a combination thereof.

23. The method of claim 21, wherein obtaining the network environment perception information comprises collecting the network environment perception information via one or more sensors of the user equipment.

24. The method of claim 23, wherein one or more sensors includes one or more cameras, an inertial measurement unit (IMU), or a combination thereof.

25. The method of claim 21, further comprising providing the network environment perception information to a network entity.

26. The method of claim 21, wherein obtaining the network environment perception information comprising receiving the network environment perception information from a network entity.

27. A method of wireless communications by a network entity, the method comprising:
outputting for transmission one or more criteria associated with triggering at least one of cell measurement or handover; and
outputting for transmission one or more updated criteria associated with triggering at least one of cell measurement or handover based at least in part on network environment perception information or signaling configuring a user equipment to autonomously update the one or more criteria based on network environment perception information.

28. The method of claim 27, further comprising determining the one or more updated criteria based on the network environment perception information.

29. A user equipment, comprising:
one or more memories comprising executable instructions; and
one or more processors configured to execute the executable instructions and, individually or collective, cause the user equipment to:
obtain one or more criteria associated with triggering at least one of cell measurement or handover; and
obtain one or more updated criteria associated with the triggering at least one of cell measurement or handover, wherein the one or more updated criteria are based at least in part on network environment perception information.

30. A network entity, comprising:
one or more memories comprising executable instructions; and
one or more processors configured to execute the executable instructions and, individually or collective, cause the network entity to:
output for transmission one or more criteria associated with triggering at least one of cell measurement or handover; and
output for transmission one or more updated criteria associated with triggering at least one of cell measurement or handover based at least in part on network environment perception information or signaling configuring a user equipment to autonomously update the one or more criteria based on network environment perception information.
